(19) United States
(12) Patent Application Publication
(10) Pub. No.: US 2019/0278553 A1
(43) Pub. Date: Sep. 12, 2019

(54) AUDIO PLAYBACK DEVICE, CONTROL DEVICE, AND CONTROL METHOD

(71) Applicant: SHARP KABUSHIKI KAISHA, Osaka (JP)

(72) Inventor: RYOJI CHISHAKI, Sakai City (JP)

(21) Appl. No.: 16/294,589

(22) Filed: Mar. 6, 2019

(30) Foreign Application Priority Data
Mar. 8, 2018 (JP) 2018-041426

(51) Int. Cl. G06F 3/16

(52) U.S. Cl. CPC G06F 3/165

(57) ABSTRACT

The present invention provides an audio playback device including: a control device; a communication device; and a storage device configured to store therein a playback list, the control device being configured to carry out: (i) a determining process in which a type of an audio output device, which is connected to the audio playback device, is determined; and (ii) a playback process in which, in a case where no playback list is designated, a playback list is obtained from the storage device in accordance with the type of the audio output device, and then audio content is played back in accordance with the playback list thus obtained.

This Nonprovisional application claims priority under U.S.C. § 119 on Patent Application No. 2018-041426 filed in Japan on Mar. 8, 2018, the entire contents of which are hereby incorporated by reference.

### TECHNICAL FIELD

The present invention relates to an audio playback device, a control device, and a control method.

### BACKGROUND ART

A tool is known by which a user can prepare, in an audio playback device, a playback list (album) so that the audio playback device plays back user's desired audio content in an order the user desires (see, for example, Non-patent Literature 1). In general, the audio playback device plays back audio content by use of a single playback list.

In a case where an audio playback device stops music playback in the middle of a playback list and then resumes playback, the device resumes playback from a previous playback stop position of this playback list, independently of whether or not a surrounding circumstance changes. For example, even in a case where another audio output device is connected, the audio playback device resumes playback from the previous playback stop position of the same playback list.

### CITATION LIST

### Non-Patent Literature

[Non-Patent Literature 1]

“GOOGLE PLAY MUSIC HELP”, [online], Google Inc., [searched on Feb. 8, 2018], The Internet <URL:https://support.google.com/googleplaymusic/answer/1250213?visit_id=1-1636492849957180567-21818890238&rd=1>

### SUMMARY OF INVENTION

### Technical Problem

According to the conventional technique, a single playback list is used unless a user selects another playback list. As such, the conventional technique has a problem that a previous playback list can be changed only when the user selects another play back list, in a case where a surrounding circumstance changes.

Accordingly, even in a case where a user prepares a plurality of playback lists in accordance with the situation, the user needs to select another playback list in accordance with the situation. In this regard, users want to listen to:
(1) a relaxing song through a speaker in a library of his/her house,
(2) an up-tempo song through a headphone during jogging, and
(3) a refreshing song through a car audio system during driving.

An object of an aspect of the present invention is to play back audio content in accordance with a surrounding circumstance.

### Solution to Problem

In order to attain the foregoing object, an audio playback device in accordance with an aspect of the present invention includes: a control device; a communication device; and a storage device configured to store therein a playback list, the control device being configured to carry out, via the communication device: (i) a determining process in which a type of an audio output device, which is connected to the audio playback device, is determined; and (ii) a playback process in which, in a case where no playback list is designated, a playback list is obtained from the storage device in accordance with the type of the audio output device, and then audio content is played back in accordance with the playback list thus obtained.

In order to attain the foregoing object, an audio playback device in accordance with an aspect of the present invention includes: a control device; a communication device; and a storage device configured to store therein a playback list, the control device being configured to carry out, via the communication device: (i) a determining process in which a use environment of the audio playback device is determined; and (ii) a playback process in which, in a case where no playback list is designated, a playback list is obtained from the storage device in accordance with the use environment, and then audio content is played back in accordance with the playback list thus obtained.

In order to attain the foregoing object, an audio playback device in accordance with an aspect of the present invention includes: a control device; a communication device; and a storage device configured to store therein a playback list, the control device being configured to carry out, via the communication device: (i) a determining process in which a state of a user, who operates the audio playback device, is determined; and (ii) a playback process in which, in a case where no playback list is designated, a playback list is obtained from the storage device, in accordance with the state of the user, and then audio content is played back in accordance with the playback list thus obtained.

In order to attain the foregoing object, a control device in accordance with an aspect of the present invention is a control device for controlling an audio playback device, the control device being configured to carry out: (i) a determining process in which a type of an audio output device, which is connected to the audio playback device, is determined; and (ii) a playback process in which, in a case where no playback list is designated, a playback list is obtained in accordance with the type of the audio output device, and then audio content is played back in accordance with the playback list thus obtained.

In order to attain the foregoing object, a control method in accordance with an aspect of the present invention is a control method for controlling an audio playback device, including the steps of: (i) determining a type of an audio output device which is connected to the audio playback device; and (ii) obtaining, in a case where no playback list is designated, a playback list in accordance with the type of the audio output device, and then playing back audio content in accordance with the playback list thus obtained.

### Advantageous Effects of Invention

With the configuration of an aspect of the present invention, it is possible to play back audio content in accordance with surrounding circumstances.

### BRIEF DESCRIPTION OF DRAWINGS

FIG. 1 illustrates a configuration of an audio playback system in accordance with Embodiment 1 of the present invention.

FIG. 2 is a block diagram illustrating a configuration of an audio playback device in accordance with Embodiment 1.

(a) through (c) of FIG. 3 are tables each illustrating a corresponding playback list in accordance with Embodiment 1.

FIG. 4 is a sequence chart illustrating how the audio playback device of Embodiment 1 switches one playback list to another.

(a) of FIG. 5 is a flowchart illustrating how the audio playback device of Embodiment 1 registers an audio output device. (b) of FIG. 5 is a flowchart illustrating how the audio playback device of Embodiment 1 conducts a playback starting operation.

(a) through (d) of FIG. 6 are tables each illustrating a corresponding playback list in accordance with Embodiment 2 of the present invention.

FIG. 7 is a sequence chart illustrating how an audio playback device of Embodiment 2 switches one playback list to another.

(a) of FIG. 8 is a flowchart illustrating how the audio playback device of Embodiment 2 registers a use environment. (b) of FIG. 8 is a flowchart illustrating how the audio playback device of Embodiment 2 conducts a playback starting operation.

(a) through (c) of FIG. 9 are tables each illustrating a corresponding playback list in accordance with Embodiment 3 of the present invention.

FIG. 10 is a sequence chart illustrating how an audio playback device of Embodiment 3 switches one playback list to another.

(a) of FIG. 11 is a flowchart illustrating how the audio playback device of Embodiment 3 registers a user's state. (b) of FIG. 11 is a flowchart illustrating how the audio playback device of Embodiment 3 conducts a playback starting operation.

### DESCRIPTION OF EMBODIMENTS

### Embodiment 1

The following description will discuss, in detail, Embodiment 1 of the present invention.

An audio playback device 1 of Embodiment 1 includes a control section 11 (control device), a communication section 16 (communication device), and a storage section 12 (storage device). The storage section 12 stores therein a playback list(s). The control section 11 carries out, via the communication section 16, (i) a determining process and (ii) a playback process. Specifically, in the determining process, a type of an audio output device, which is connected to the audio playback device 1, is determined. In the playback process, in a case where no playback list is designated, a playback list is obtained from the storage section 12 in accordance with the type of the audio output device, and then audio content is played back in accordance with the playback list thus obtained.

The control section 11 of Embodiment 1 is configured to control the audio playback device 1. Specifically, the control section 11 carries out (i) a determining process and (ii) a playback process. Specifically, in the determining process, a type of an audio output device, which is connected to the audio playback device 1, is determined. In the playback process, in a case where no playback list is designated, a playback list is obtained in accordance with the type of the audio output device, and then audio content is played back in accordance with the playback list thus obtained.

A control method of Embodiment 1 is a control method for controlling the audio playback device 1. The control method includes the steps of (i) determining a type of an audio output device, which is connected to the audio playback device 1, and (ii) obtaining, in a case where no playback list is designated, a playback list in accordance with the type of the audio output device and then playing back audio content in accordance with the playback list thus obtained.

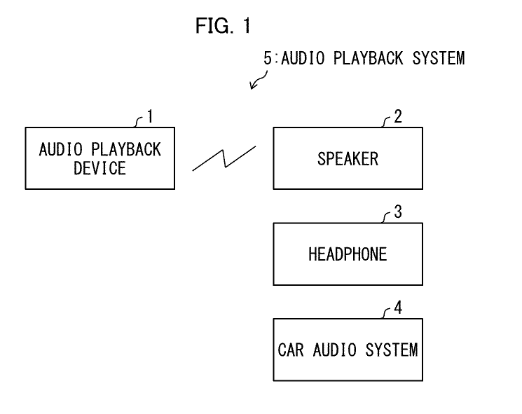

FIG. 1 illustrates a configuration of an audio playback system 5 of Embodiment 1. As illustrated in FIG.

1, the audio playback system 5 includes the audio playback device 1 and audio output devices such as a speaker 2, a headphone 3, and a car audio system 4. The audio playback device 1 is a system which causes the audio output device connected thereto via radio communication, to output audio data.

(Configuration of Audio Playback Device 1)

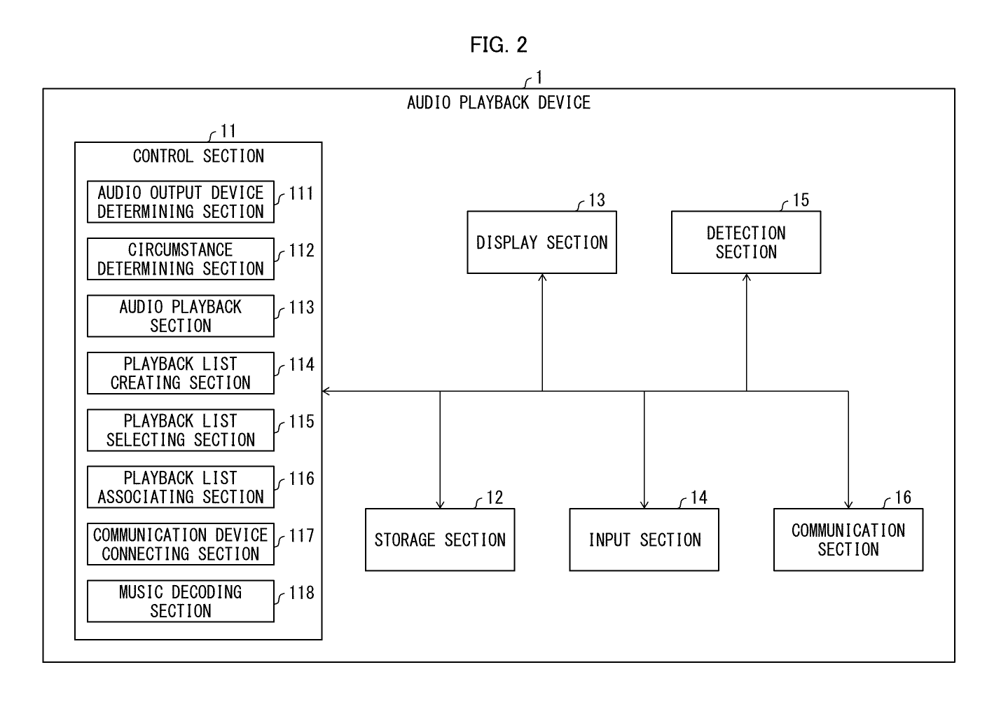

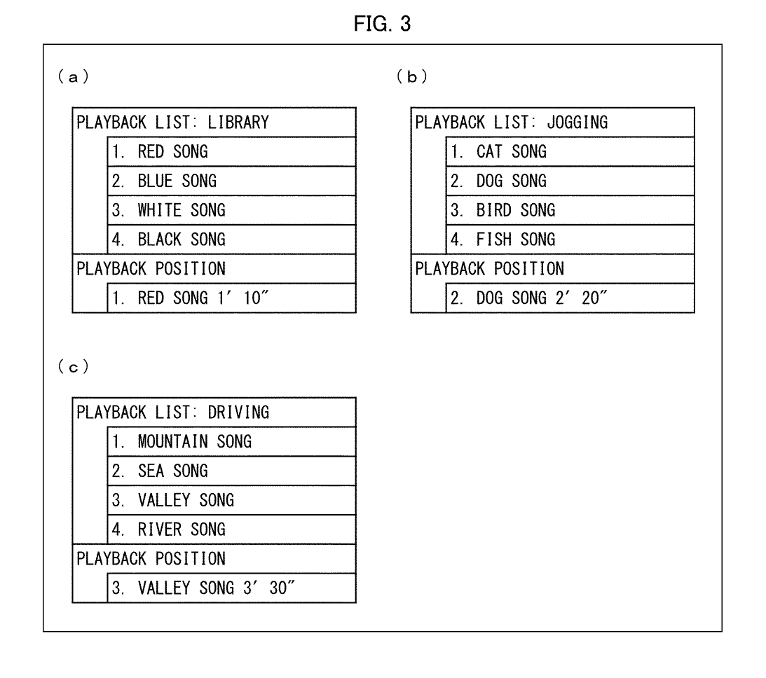

FIG. 2 is a block diagram illustrating a configuration of the audio playback device 1 of Embodiment 1. As illustrated in FIG. 2, the audio playback device 1 includes the control section 11, the storage section 12, a display section 13, an input section 14, a detection section 15, and the communication section 16.

The control section 11 controls the entire audio playback device 1. The control section 11 is configured, for example, by a central processing unit (CPU). For example, the control section 11 carries out (i) an information acquiring process in which information, about an audio output device connected (e.g. a type), is obtained via the communication section 16, (ii) a process in which the type of the audio output device thus obtained is associated with a playback list, (iii) a playback list selecting process in which a playback list is selected, and (iv) a storage process in which the storage section is controlled to save therein a playback position for each playback list. Note that the playback list causes the audio playback device to play back user's desired audio content in an order the user desires.

As illustrated in FIG. 2, the control section 11 includes, as a software module, an audio output device determining section 111, a circumstance determining section 112, an audio playback section 113, a playback list creating section 114, a playback list selecting section 115, a playback list associating section 116, a communication device connecting section 117, and a music decoding section 118.

The audio output device determining section 111 determines a type of an audio output device connected to the audio playback device 1. The circumstance determining section 112 determines a surrounding circumstance based on information which has been obtained via the detection section 15. Note that the surrounding circumstance refers to, for example, (i) a type of an audio output device connected to the audio playback device 1, (ii) an environment (use environment) in which the audio playback device is used (e.g., user's location or action), and (iii) a user's state (e.g., a stressed state or a rest state). The audio playback section 113 obtains from the storage section 12 a playback list in accordance with a type of the audio output device, connected thereto, and controls the audio output device to output audio data, so as to play back audio content in accordance with the playback list thus obtained. The playback list creating section 114 creates a playback list in accordance with a user's operation. The playback list associating section 116 associates each playback list, created by the playback list creating section 114, with a corresponding audio output device.

The playback list selecting section 115 selects, from stored playback lists, a playback list which is associated with the audio output device connected. The communication device connecting section 117 pairs the audio output device thus connected and the audio playback device 1 via the communication section 16. The audio output device outputs its device name when being paired by the communication device connecting section 117. Based on the device name, the communication device connecting section 117 can identify a type of the audio output device connected thereto. The music decoding section 118 decodes audio content.

The storage section 12 stores therein, for example, registration information about each audio output device, a playback list, audio content, and an association between respective audio output devices and respective playback lists. Examples of the storage section 12 include a hard disk drive (HDD) and a solid state drive (SSD). The display section 13 displays a playback list and the like. The display section 13 is realized, for example, by a display. The input section 14 accepts, for example, a user's operation of switching one playback list to another. Examples of the input section 14 include a button and a touch panel. The detection section 15 detects a change in position, height, and the like of the audio playback device 1. Examples of the detection section 15 include an acceleration sensor, a geomagnetic sensor, and a global positioning system (GPS) receiver.

The communication section 16 receives information about external devices, connected to the audio playback device 1, such as an audio output device and an activity meter. A communication between the audio playback device 1 and the audio output device is not limited to a specific one. Examples of the communication include communications via Bluetooth (registered trademark), WiFi (registered trademark), a mobile communication network, and other communications.

Each playback list for a corresponding audio output device can be created and/or edited in advance by a user interface (UI) operation.

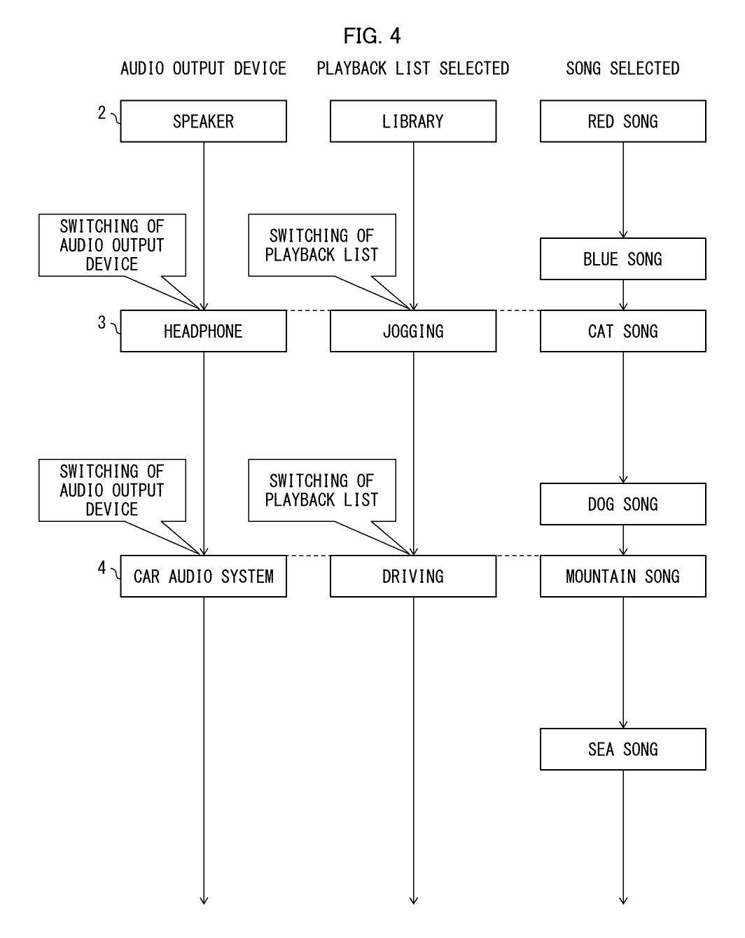

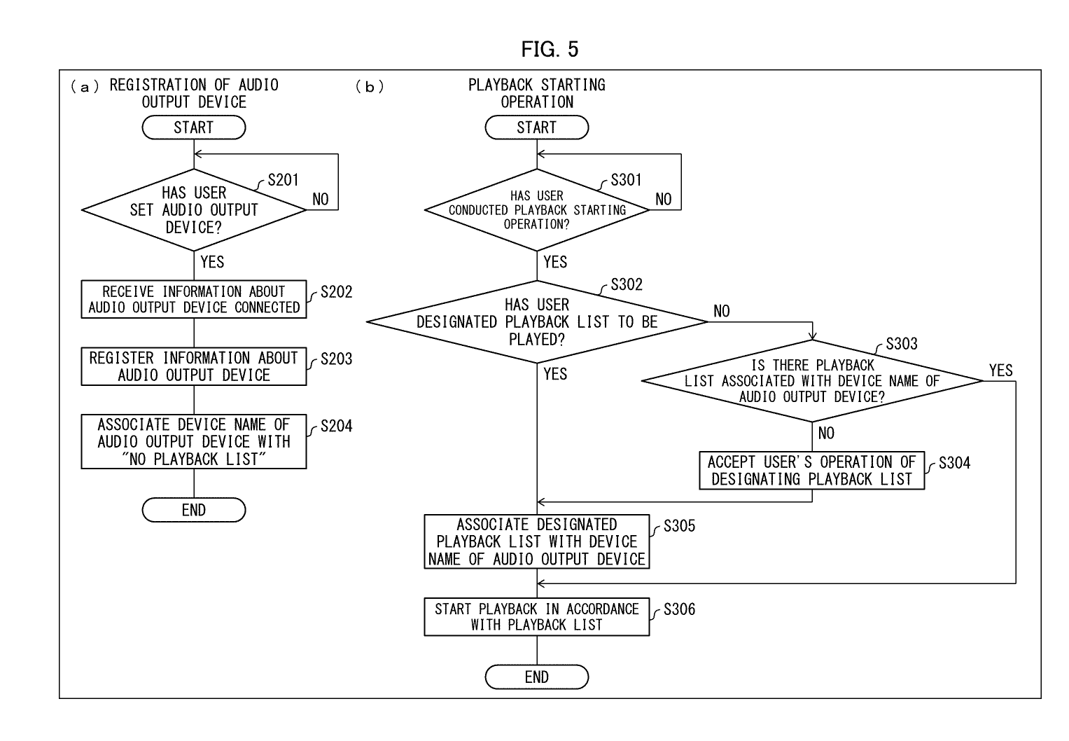

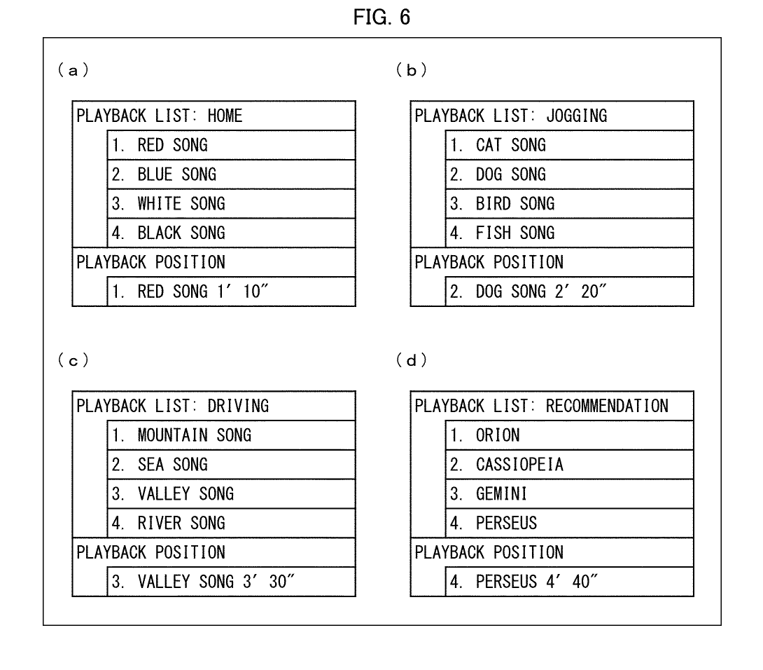

(a) through (c) of FIG. 3 are tables each illustrating a playback list in accordance with Embodiment 1. FIG. 4 is a sequence chart illustrating how the audio playback device of Embodiment 1 switches one playback list to another.

“Playback list: library” (see (a) of FIG. 3) is associated with the speaker 2. As illustrated in (a) of FIG. 3, “1. red song,” “2. blue song,” “3. white song,” and “4. black song” are registered, in this order, in the “playback list: library.”

“Playback list: jogging” (see (b) of FIG. 3) is associated with the headphone 3. As illustrated in (b) of FIG. 3, “1. cat song,” “2. dog song,” “3. bird song,” and “4. fish song” are registered, in this order, in the “playback list: jogging.”

“Playback list: driving” (see (c) of FIG. 3) is associated with the car audio system 4. As illustrated in (c) of FIG. 3, “1. mountain song,” “2. sea song,” “3. valley song,” and “4.

river song” are registered, in this order, in the “playback list: driving.”

In a case where the speaker 2 is connected to the audio playback device 1, the audio playback device 1 uses the “playback list: library” so as to successively play back songs from “1. red song” (see FIG. 4).

In a case where the audio output device is switched from the speaker 2 to the headphone 3, the audio playback device 1 uses the “playback list: jogging” so as to successively play back songs from “1. cat song.”

In a case where the audio output device is switched from the headphone 3 to the car audio system 4, the audio playback device 1 uses the “playback list: driving” so as to successively play back songs from “1. mountain song.”

Note that in a case where the audio playback device 1 stops music playback and then resumes playback, the audio playback device 1 resumes playback from a previous playback stop position of a playback list associated with an audio output device being currently connected, independently of a previously connected audio output device.

For example, in a case where (i) playback of the “playback list: library” previously came to a stop at 1′10″ of “1. red song” (see (a) of FIG. 3) and (ii) the “playback list: library” is next selected and played back, the audio playback device 1 resumes playback of the “playback list: library” from 1′10″ of the “1. red song.”

In a case where (i) playback of the “playback list: jogging” previously came to a stop at 2′20″ of “2. dog song” (see (b) of FIG. 3) and (ii) the “playback list: jogging” is next selected and played back, the audio playback device 1 resumes playback of the “playback list: jogging” from 2′20″ of the “2. dog song.”

In a case where (i) playback of the “playback list: driving” previously came to a stop at 3′30″ of “3. valley song” (see (c) of FIG. 3) and (ii) the “playback list: driving” is next selected and played back, the audio playback device 1 resumes playback of the “playback list: driving” from 3′30″ of the “3. valley song.”

It is also possible that a user designates a desired playback list via the input section 14. In this case, based on a user's designation operation, entered via the input section 14, the control section 11 identifies the thus-designated playback list.

(Process of Audio Playback Device 1)

(a) of FIG. 5 is a flowchart illustrating how the audio playback device 1 of Embodiment 1 resisters an audio output device.

(Step S201)

The control section 11 of the audio playback device 1 first determines whether or not a user has set an audio output device connected, via the input section 14. In a case where the audio playback device 1 determines that the user has set the audio output device connected (YES in step S201), the control section 11 proceeds with step S202. In a case where the audio playback device 1 determines that the user has not set the audio output device connected (NO in step S201), the control section 11 makes the determination in step S201 once again.

(Step S202)

Next, the communication device connecting section 117 receives, via the communication section 16, information about the audio output device connected (e.g., a device name).

(Step S203)

Subsequently, the communication device connecting section 117 registers the received information about the audio output device.

(Step S204)

The playback list associating section 116 associates the registered device name (type) of the audio output device with “no playback list.”

(b) of FIG. 5 is a flowchart illustrating how the audio playback device 1 of Embodiment 1 conducts a playback starting operation.

(Step S301)

The control section 11 of the audio playback device 1 first determines whether or not a user has conducted a playback starting operation via the input section 14. In a case where the control section 11 determines that the user has conducted the playback starting operation (YES in step S301), the control section 11 makes a determination in step S302. In a case where the control section 11 determines that the user has not conducted the playback starting operation (NO in step S301), the control section 11 makes the determination in step S301 once again.

(Step S302)

The playback list selecting section 115 determines whether or not the user has designated a playback list to be played.

In a case where the playback list selecting section 115 determines that the user has designated a playback list to be played (YES in step S302), the playback list selecting section 115 outputs information about the thus-designated playback list to the playback list associating section 116. Then, the control section 11 proceeds with step S305.

In a case where the playback list selecting section 115 determines that the user has not designated a playback list to be played (NO in step S302), the playback list selecting section 115 makes a determination in step 5303.

(Step S303)

The playback list selecting section 115 determines whether or not there is a playback list which is associated with the device name of the audio output device connected.

In a case where the playback list selecting section 115 determines that there is a playback list which is associated with the device name of the audio output device connected (YES in step S303), the control section 11 proceeds with step S306.

In a case where the playback list selecting section 115 determines that there is no playback list which is associated with the device name of the audio output device connected (NO in step S303), the control section 11 proceeds with step S304.

(Step S304)

The control section 11 controls the display section 13 to display a message which urges the user to designate a desired playback list (e.g., “Please designate your preferred playback list.”). Then, the control section 11 accepts a user's designation operation entered via the input section 14, and then outputs, to the playback list associating section 116, information about the playback list designated by the user.

(Step S305)

The playback list associating section 116 associates the device name of the audio output device connected, with the playback list designated by the user.

(Step S306)

The audio playback section 113 obtains, from the storage section 12, the playback list associated with the device name of the audio output device connected, and then plays back audio content in accordance with the playback list thus obtained. Specifically, the audio playback section 113 plays back audio content, stored in the storage section 12, in accordance with the playback list while outputting corresponding audio data to the audio output device (e.g., the speaker 2, the headphone 3, or the car audio system 4), via the communication section 16.

### Effect of Embodiment 1

According to Embodiment 1, in a case where another audio playback device is connected, the audio playback device (i) selects a playback list in accordance with the audio output device thus connected, and then (ii) plays back audio content in accordance with the playback list thus selected. It is therefore possible to switch a playback list to another playback list in accordance with switching of the audio output device, instead of a user selecting a playback list.

With the configuration of Embodiment 1, in a case where the audio playback device stops music playback and then resumes playback, the audio playback device resumes playback from a previous playback stop position of a playback list associated with an audio output device being currently connected, independently of a previously connected audio output device. This makes it possible to uniform the frequency at which each audio content, in a playback list, is played back. In other words, each audio content, in a playback list, can be evenly played back.

### Embodiment 2

The following description will discuss Embodiment 2 of the present invention. Note that, for convenience, members having the same functions as those described in Embodiment 1 are given the same reference numerals and their descriptions will be omitted.

An audio playback device 1 in accordance with Embodiment 2 of the present invention includes a control section 11, a communication section 16, and a storage section 12. The storage section 12 stores therein a playback list(s), and the control section 11 carries out, via the communication section 16, (i) a determining process and (ii) a playback process. Specifically, in the determining process, a use environment of the audio playback device 1 is determined. In the playback process, in a case where no playback list is designated, a playback list is obtained from the storage section 12 in accordance with the use environment of the audio playback device 1, and then audio content is played back in accordance with the playback list thus obtained.

The audio playback device 1 of Embodiment 2 further includes a motion sensor or a GPS receiver. Examples of the motion sensor include an acceleration sensor and a geomagnetic sensor. The GPS receiver receives a GPS signal from a GPS satellite so as to identify a current location of the audio playback device 1.

The control section 11 carries out, for example, (i) an information acquiring process and (ii) an association process. Specifically, in the information acquiring process, information about a use environment of the audio playback device 1 is obtained from the motion sensor, the GPS receiver, or an application that is loaded from the storage section 12 and is then executed. In the association process, the use environment thus obtained is associated with a playback list. The application indicates installed application software. Examples of the application include a route saving application and a car navigation application. The storage section 12 stores therein, for example, registration information about the use environment of the audio playback device 1.

A circumstance determining section 112 identifies the use environment of the audio playback device 1 (e.g., “at home”; “while jogging”; “at friend's house”; or “while driving”) based on the information obtained from the motion sensor, the GPS receiver, or the application which is loaded from the storing section 12 and is then executed. An audio playback section 113 obtains, from the storage section 12, a playback list in accordance with the use environment identified, and then plays back audio content in accordance with the playback list thus obtained. A playback list associating section 116 associates each playback list created by a playback list creating section 114 with a corresponding use environment. A playback list selecting section 115 selects, from stored playback lists, a playback list associated with the thus-identified use environment of the audio playback device. The playback list selecting section 115 carries out a playback list selecting process in which a playback list is switched to another playback list in accordance with a change in use environment.

Each playback list for a corresponding use environment can be created and/or edited in advance by a UI operation.

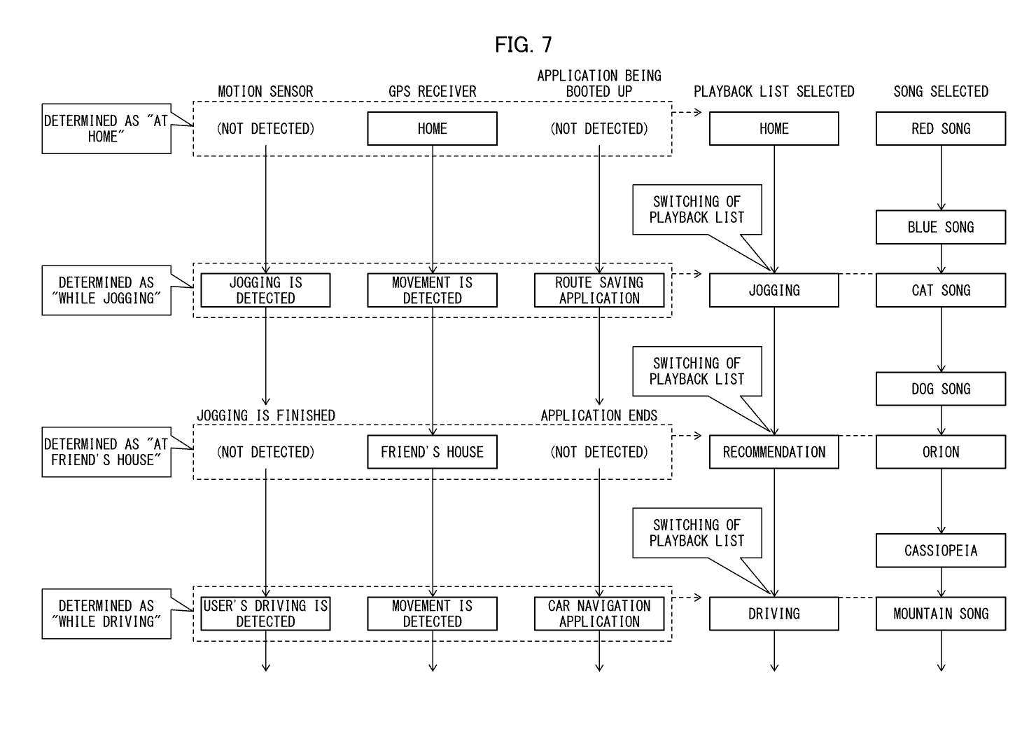

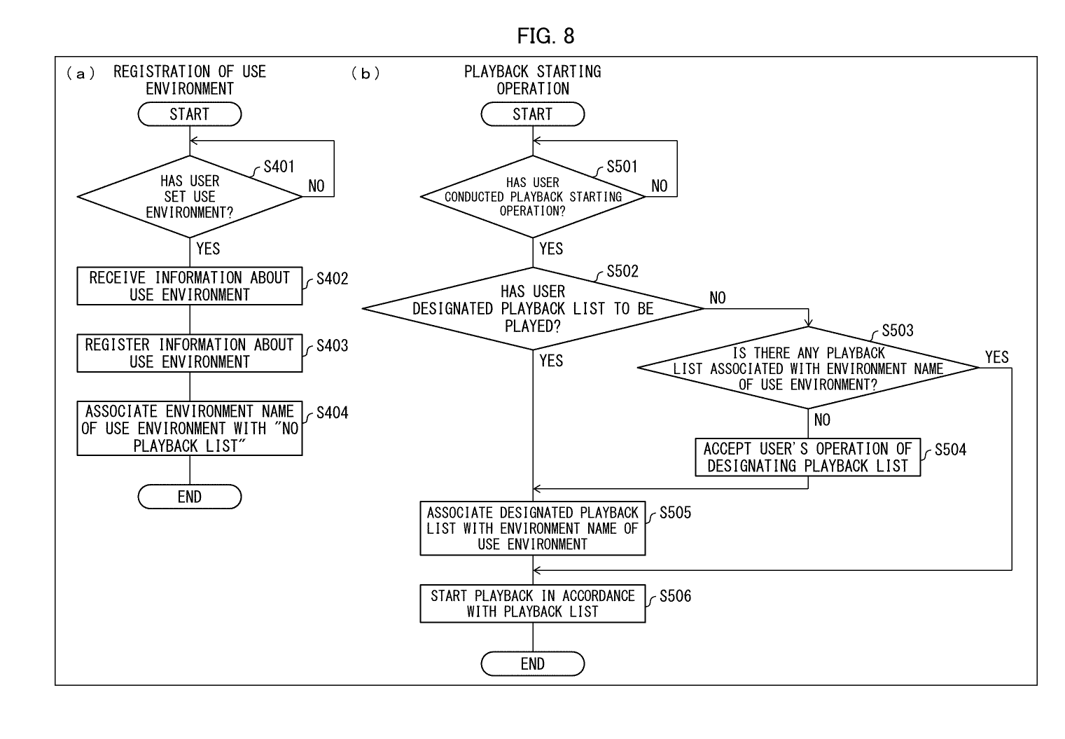

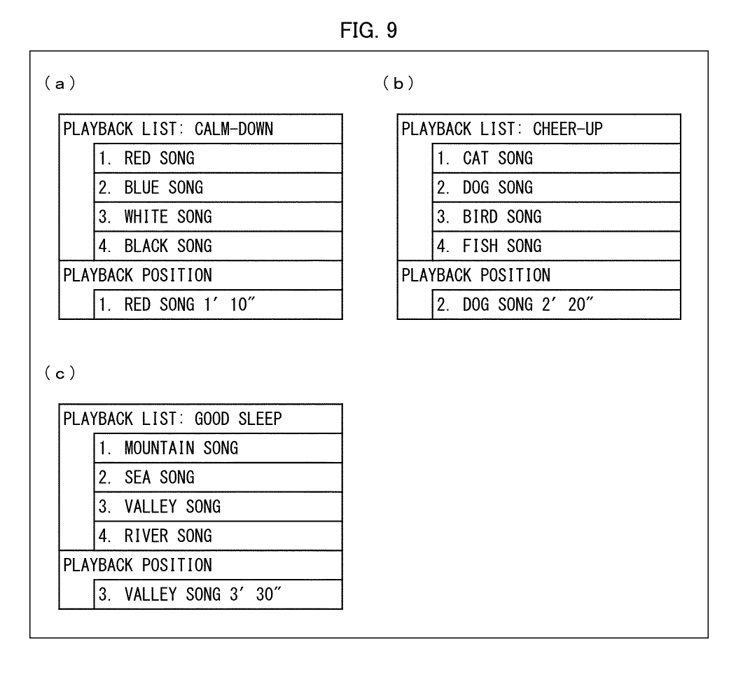

(a) through (d) of FIG. 6 are tables each illustrating a corresponding playback list in accordance with Embodiment 2. FIG. 7 is a sequence chart illustrating how the audio playback device of Embodiment 2 switches one playback list to another.

For example, in a case where the GPS receiver detects a user, who carries the audio playback device 1, being at home, the circumstance determining section 112 determines a use environment as “at home” and then, “playback list: home” ((a) of FIG. 6) is associated with this use environment. As is illustrated in (a) of FIG. 6, “1. red song,” “2. blue song,” “3. white song,” and “4. black song” are registered, in this order, in the “playback list: home.”

In a case where (i) the motion sensor detects the user, who carries the audio playback device 1, being jogging, (ii) the GPS receiver detects a movement of the user carrying the device, and (iii) the route saving application is being booted up, the circumstance determining section 112 determines a use environment as “while jogging” and then, “playback list: jogging” ((b) of FIG. 6) is associated with this use environment. As illustrated in (b) of FIG. 6, “1. cat song,” “2. dog song,” “3. bird song,” and “4. fish song” are registered, in this order, in the “playback list: jogging.

In a case where (i) the motion sensor detects the user, who carries the audio playback device 1, being driving, (ii) the GPS receiver detects a movement of the user carrying the device, and (iii) a car navigation application is being booted up, the circumstance determining section 112 determines a use environment as “while driving” and then, “playback list: driving” ((c) of FIG. 6) is associated with this environment. As illustrated in (c) of FIG. 6, “1. mountain song,” “2. sea song,” “3. valley song,” and “4. river song” are registered, in this order, in the “playback list: driving.”

In a case where the GPS receiver detects the user, who carries the audio playback device 1, being in a friend's house, the circumstance determining section 112 determines a use environment as “at friend's house” and then, “playback list: recommendation” ((d) of FIG. 6) is associated with this use environment. As illustrated in (d) of FIG. 6, “1. Orion,” “2. Cassiopeia,” “3. Gemini,” and “4. Perseus” are registered, in this order, in the “playback list: recommendation.”

As illustrated in FIG. 7, in a case where the circumstance determining section 112 determines a use environment as “at home,” based on the fact that the GPS receiver detects the user, who carries the audio playback device 1, being at home, the audio playback device 1 uses the “playback list: home” so as to successively play back songs from “1. red song”.

Further, in a case where the circumstance determining section 112 determines the use environment as “while jogging” based on the fact that (i) the motion sensor detects the user, who carries the audio playback device 1, being jogging, (ii) the GPS receiver detects a movement of the user carrying the device, and (iii) the route saving application is being booted up, the audio playback device 1 uses the “playback list: jogging” so as to successively play back songs from “1. cat song.”

Still further, in a case where the circumstance determining section 112 determines the use environment as “at friend's house” based on the fact that the GPS receiver detects the user, who carries the audio playback device 1, being in a friend's house, the audio playback device 1 uses the “playback list: recommendation” so as to successively play back songs from “1. Orion.”

Furthermore, in a case where the circumstance determining section 112 determines the use environment as “while driving” based on the fact that (i) the motion sensor detects the user, who carries the audio playback device 1, being driving, (ii) the GPS receiver detects a movement of the user carrying the device, and (iii) the car navigation application is being booted up, the audio playback device 1 uses the “playback list: driving” so as to successively play songs from “1. mountain song.”

Note that in a case where the audio playback device 1 stops music playback and then resumes playback, the audio playback device 1 resumes playback from a previous playback stop position of a playback list associated with a current use environment, independently of a previous use environment.

For example, in a case where (i) playback of the “playback list: home” previously came to a stop at 1′10″ of “1. red song” (see (a) of FIG. 6) and (ii) the “playback list: home” is next selected and played back, the audio playback device 1 resumes playback of the “playback list: home” from 1′10″ of “1. red song.”

In a case where (i) playback of the “playback list: jogging” previously came to a stop at 2′20″of “2. dog song” (see (b) of FIG. 6) and (ii) the “playback list: jogging” is next selected and played back, the audio playback device 1 resumes playback of the “playback list: jogging” from 2′20″ of “2. dog song.”

In a case where (i) playback of the “playback list: driving” previously came to a stop at 3′30″ of “3. valley song” (see (c) of FIG. 6) and (ii) the “playback list: driving” is next selected and played back, the audio playback device 1 resumes playback of the “playback list: driving” from 3′30″ of “3. valley song.”

In a case where (i) playback of the “playback list: recommendation” previously came to a stop at 4′40″ of “4. Perseus” (see (d) of FIG. 6) and (ii) the “playback list: recommendation” is next selected and played back, the audio playback device 1 resumes playback of the “playback list: recommendation” from 4′40″ of “4. Perseus.”

(Process of Audio Playback Device 1)

(a) of FIG. 8 is a flowchart illustrating how the audio playback device 1 of Embodiment 2 registers a use environment.

(Step S401)

The control section 11 of the audio playback device 1 first determines whether or not a user has set a use environment, via an input section 14. In a case where the control section 11 determines that the user has set the use environment (YES in step S401), the control section 11 proceeds with step S402. In a case where the control section 11 determines that the user has not set the use environment (NO in step S401), the control section 11 makes the determination in step S401 once again.

(Step S402)

Then, a communication device connecting section 117 receives information about the use environment thus set (e.g., an environment name), via the communication section 16.

(Step S403)

Subsequently, the communication device connecting section 117 registers the received information about the use environment.

(Step S404)

A playback list associating section 116 associates the registered environment name with “no playback list.”

(b) of FIG. 8 is a flowchart illustrating how the audio playback device 1 of Embodiment 2 conducts a playback starting operation.

(Step S501)

The control section 11 of the audio playback device 1 first determines whether or not a user has conducted a playback starting operation via the input section 14. In a case where the control section 11 determines that the user has conducted the playback starting operation (YES in step S501), the control section 11 makes a determination in step S502. In a case where the control section 11 determines that the user has not conducted the playback starting operation (NO in step S501), the control section 11 makes the determination in step S501 once again.

(Step S502)

The playback list selecting section 115 determines whether or not the user has designated a playback list to be played.

In a case where the playback list selecting section 115 determines that the user has designated a playback list to be played (YES in step S502), the playback list selecting section 115 outputs information about the thus-designated playback list to the playback list associating section 116. Subsequently, the control section 11 proceeds with step S505.

In a case where the playback list selecting section 115 determines that the user has not designated a playback list to be played (NO in step S502), the playback list selecting section 115 makes a determination in step S503.

(Step S503)

The playback list selecting section 115 determines whether or not there is a playback list which is associated with the environment name of the use environment registered.

In a case where the playback list selecting section 115 determines that there is a playback list which is associated with the environment name of the use environment registered (YES in step S503), the control section 11 proceeds with step S506.

In a case where the playback list selecting section 115 determines that there is no playback list which is associated with the environment name of the use environment registered (NO in step S503), the control section 11 proceeds with step S504.

(Step S504)

The control section 11 controls the display section 13 to display a message which urges the user to designate a desired playback list (e.g., “Please designate your preferred playback list.”). The control section 11 accepts a user's designation operation entered via the input section 14, and then outputs, to the playback list associating section 116, information about the playback list designated by the user.

(Step S505)

The playback list associating section 116 associates the environment name of the use environment registered, with the playback list designated by the user.

(Step S506)

The audio playback section 113 obtains, from the storage section 12, the playback list associated with the environment name of the use environment registered, and then plays back audio content in accordance with the playback list thus obtained.

### Effect of Embodiment 2

With the configuration of Embodiment 2, in a case of where a use environment of the audio playback device is changed, the audio playback device selects a playback list in accordance with the change in use environment, and then plays back audio content in accordance with the playback list thus selected. It is therefore possible to switch a playback list to another playback list in accordance with a change in use environment, instead of a user selecting a playback list.

### Embodiment 3

The following description will discuss Embodiment 3 of the present invention. Note that, for convenience, members having the same functions as those described in Embodiments 1 and 2 are given the same reference numerals and their descriptions will be omitted.

An audio playback device 1 in accordance with Embodiment 3 of the present invention includes a control section 11, a communication section 16, and a storage section 12. The storage section 12 stores therein a playback list(s). The control section 11 carries out, via a communication section 16, (i) a determining process and (ii) a playback process. Specifically, in the determining process, a state of a user (hereinafter also simply referred to as a user' state), who operates the audio playback device 1, is determined. In the playback process, in a case where no playback list is designated, a playback list is obtained from the storage section 12 in accordance with the thus-determined user's state, and then audio content is played back in accordance with the playback list thus obtained.

The audio playback device 1 of Embodiment 3 further includes a human body sensor or a clock. Examples of the human body sensor include a pulse sensor, a blood pressure sensor, a body temperature sensor, an acceleration sensor, and a geomagnetic sensor. Examples of the clock include a radio clock and a clock of which the time is set by a user.

The control section 11 carries out, for example, (i) an information acquiring process and (ii) an association process. Specifically, in the information acquiring process, information about a user's state is obtained from the human body sensor or the clock. In the association process, the thus-obtained information about the user's state is associated with a corresponding playback list. The storage section 12 stores therein, for example, registration information about the user's state.

A circumstance determining section 112 identifies a user's state (e.g., “stressed,” “rest,” or “sleeping”), based on the information obtained from the human body sensor or the clock. An audio playback section 113 obtains, from the storage section 12, a playback list in accordance with a user's state, and then plays back audio content in accordance with the playback list thus obtained. A playback list associating section 116 associates each playback list, which is created by a playback list creating section 114, with a corresponding user's state. A playback list selecting section 115 selects, from stored playback lists, a playback list associated with a user's state. The playback list selecting section 115 carries out a playback list selecting process in which a playback list is switched to another playback list in accordance with a change in user's state.

Each playback list for a corresponding user's state can be created and/or edited in advance by a UI operation.

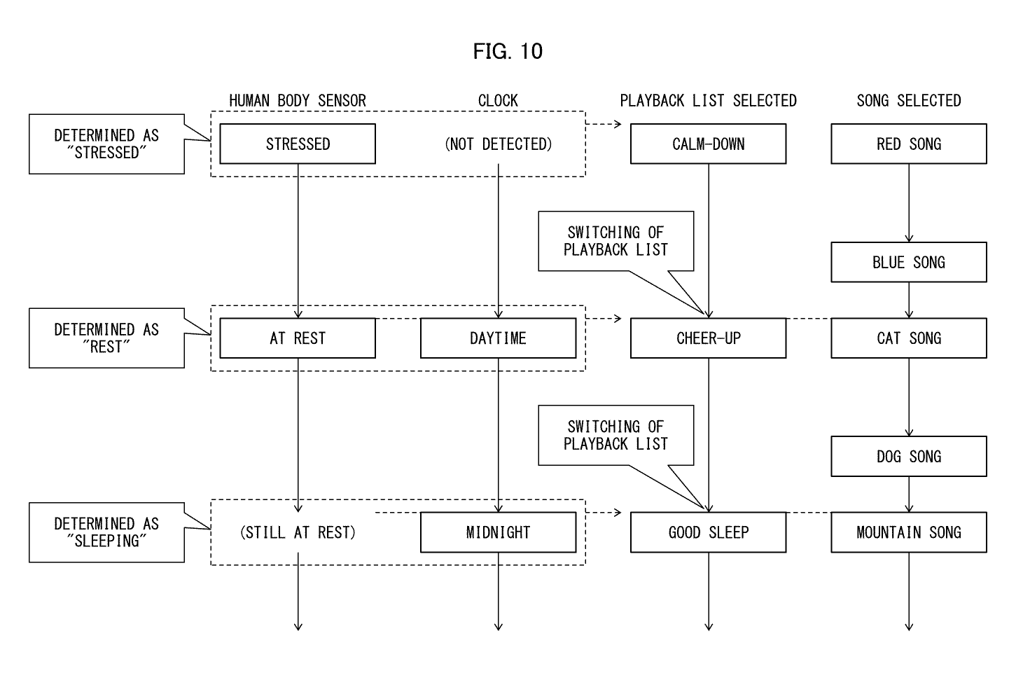

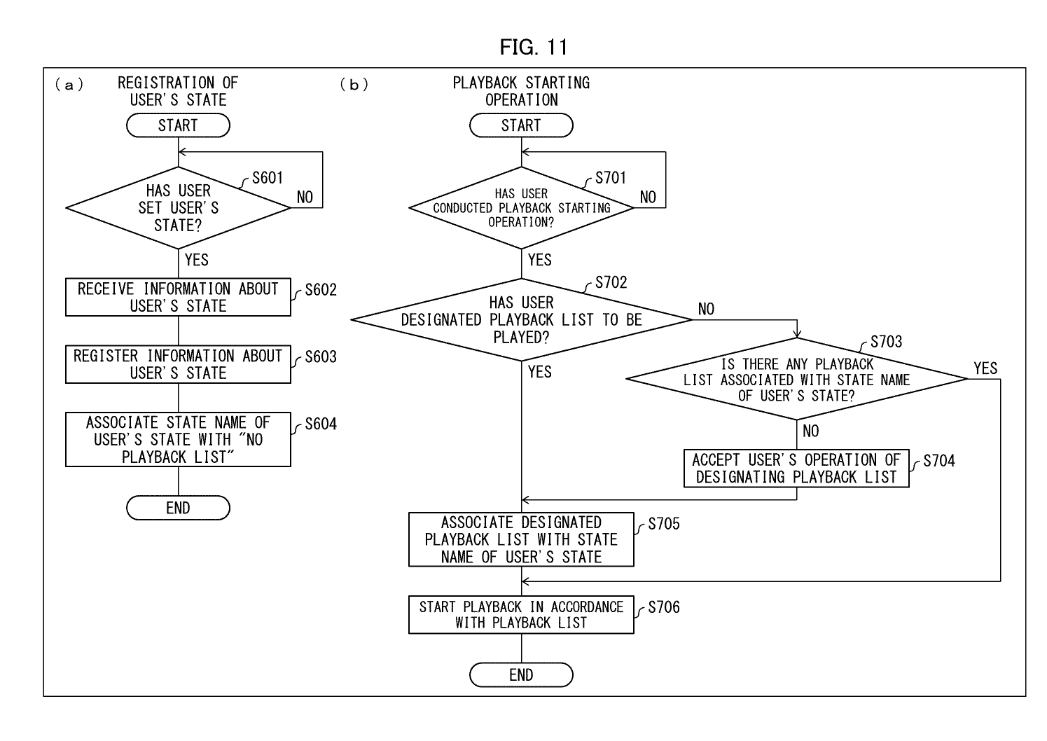

(a) through (c) of FIG. 9 are tables each illustrating a playback list of Embodiment 3. FIG. 10 is a sequence chart illustrating how the audio playback device of Embodiment 3 switches one playback list to another.

In a case where the human body sensor detects a user, who carries the audio playback device 1, being stressed, the circumstance determining section 112 determines a user's state as “stressed” and then, “playback list: calm-down” (see (a) of FIG. 9) is associated with this user's state. As illustrated in (a) of FIG. 9, “1. red song,” “2. blue song,” “3. white song,” and “4. black song” are registered, in this order, in the “playback list: calm-down.”

In a case where (i) the human body sensor detects the user, who carries the audio playback device, being at rest and (ii) the clock detects daytime, the circumstance determining section 112 determines a user's state as “rest” and then, “playback list: cheer-up” (see (b) of FIG. 9) is associated with this user's state. As illustrated in (b) of FIG. 9, “1. cat song,” “2. dog song,” “3. bird song,” and “4. fish song” are registered, in this order, in the “playback list: cheer-up.”

In a case where (i) the human body sensor detects the user, who carries the audio playback device, being at rest and (ii) the clock detects late-evening, the circumstance determining section 112 determines a user's state as “sleeping” and then, “playback list: good sleep” (see (c) of FIG. 9) is associated with this user's state. As illustrated in (c) of FIG. 9, “1. mountain song,” “2. sea song,” “3. valley song,” and “4. river song” are registered, in this order, in the “playback list: good sleep.”

In a case where the circumstance determining section 112 determines the user's state as “stressed” based on the fact that the human body sensor detects the user, who carries the audio playback device, being stressed, the audio playback device 1 uses “playback list: calm-down” so as to successively play back songs from “1. red song” (see FIG. 10).

Further, in a case where the circumstance determining section 112 determines the user's state as “rest,” based on the fact that (i) the human body sensor detects the user, who carries the audio playback device, being at rest and (ii) the clock detects daytime, the audio playback device 1 uses “playback list: cheer-up” so as to successively play back songs from “1. cat song.”

Still further, in a case where the circumstance determining section 112 determines the user's state as “sleeping,” based on the fact that (i) the human body sensor still detects the user, who carries the audio playback device, being at rest and (ii) the clock detects late-evening, the audio playback device 1 uses “playback list: good sleep” so as to successively play back songs from “1. mountain song.”

Note that in a case where the audio playback device 1 stops music playback and then resumes playback, the audio playback device 1 resumes playback from a previous playback stop position of a playback list associated with a current user's state, independently of a previous user's state.

For example, in a case where (i) playback of the “playback list: calm-down” previously came to a stop at 1′10″ of “1. red song” (see (a) of FIG. 9) and (ii) the “playback list: calm-down” is next selected and played back, the audio playback device 1 resumes playback of the “playback list: calm-down” from 1′10″ of “1. red song.”

In a case where (i) playback of the “playback list: cheer-up” previously came to a stop at 2′20″ of “2. dog song” (see (b) of FIG. 9) and the “playback list: cheer-up” is next selected and played back, the audio playback device 1 resumes playback of the “playback list: cheer-up” from 2′20″ of “2. dog song.”

In a case where playback of the “playback list: good sleep” previously came to a stop at 3′30″of “3. valley song” (see (c) of FIG. 9) and the “playback list: good sleep” is next selected and played back, the audio playback device 1 resumes playback of the “playback list: good sleep” from 3′30″ of “3. valley song.”

(Process of Audio Playback Device 1)

(a) of FIG. 11 is a flowchart illustrating how the audio playback device 1 of Embodiment 3 registers a user's state.

(Step S601)

The control section 11 of the audio playback device 1 first determines whether or not a user has set a user's state via the input section 14. In a case where the control section 11 determines that the user has set the user's state (YES in step S601), the control section 11 proceeds with step S602. In a case where the control section 11 determines that the user has not set the user's state (NO in step S601), the control section 11 makes the determination in step S601 once again.

(Step S602)

The communication device connecting section 117 receives, via the communication section 16, information about the user's state thus set (e.g., a state name).

(Step S603)

The communication device connecting section 117 registers the received information about the user's state.

(Step S604)

The playback list associating section 116 associates the state name of the user's state registered, with “no playback list.”

(b) of FIG. 11 is a flowchart illustrating how the audio playback device 1 of Embodiment 3 conducts a playback starting operation.

(Step S701)

The control section 11 of the audio playback device 1 first determines whether or not a user has conducted a playback starting operation, via the input section 14. In a case where the control section 11 determines that the user has conducted the playback starting operation (YES in step S701), the control section 11 makes a determination in step S702. In a case where the control section 11 determines that the user has not conducted the playback starting operation (NO in step S701), the control section 11 makes the determination in step S701 once again.

(Step S702)

The playback list selecting section 115 determines whether or not the user has designated a playback list to be played.

In a case where the playback list selecting section 115 determines that the user has designated a playback list to be played (YES in step S702), the playback list selecting section 115 outputs information about the thus-designated playback list to the playback list associating section 116. Then, the control section 11 proceeds with step S705.

In a case where the playback list selecting section 115 determines that the user has not designated a playback list to be played (NO in step S702), the playback list selecting section 115 makes a determination in step S703.

(Step S703)

The playback list selecting section 115 determines whether or not there is a playback list which is associated with the state name of the user's state registered.

In a case where the playback list selecting section 115 determines that there is a playback list which is associated with the state name of the user's state registered (YES in step S703), the control section 11 proceeds with step S706.

In a case where there is no playback list which is associated with the state name of the user's state registered (NO in step S703), the control section 11 proceeds with step S704.

(Step S704)

The control section 11 controls the display section 13 to display a message which urges a user to designate a desired playback list (e.g., “Please designate your preferred playback list.”). Then, the control section 11 accepts a user's designation operation entered via the input section 14, and then outputs, to the playback list associating section 116, information about the playback list designated by the user.

(Step S705)

The playback list associating section 116 associates the state name of the user's state registered, with the playback list designated by the user.

(Step S706)

The audio playback section 113 obtains, from the storage section 12, the playback list which is associated with the state name of the user's state registered, and then plays back audio content in accordance with the playback list thus obtained.

### Effect of Embodiment 3

With the configuration of Embodiment 3, in a case where a user's state is changed, the audio playback device selects a playback list in accordance with the change in user's state, and then plays back audio content in accordance with the playback list thus selected. It is therefore possible to switch a playback list to another playback list in accordance with a change in user's state, instead of the user selecting a playback list.

### [Recap]

An audio playback device (1) in accordance with a first aspect of the present invention includes: a control device (11); a communication device (16); and a storage device (12) configured to store therein a playback list, the control device being configured to carry out, via the communication device: (i) a determining process in which a type of an audio output device (a speaker 2, a headphone 3, and a car audio system 4), which is connected to the audio playback device, is determined; and (ii) a playback process in which, in a case where no playback list is designated, a playback list is obtained from the storage device in accordance with the type of the audio output device, and then audio content is played back in accordance with the playback list thus obtained.

The configuration allows the audio playback device to play back audio content in accordance with a type of an audio output device connected thereto.

An audio playback device in accordance with a second aspect of the present invention includes: a control device; a communication device; and a storage device configured to store therein a playback list, the control device being configured to carry out, via the communication device: (i) a determining process in which a use environment of the audio playback device is determined; and (ii) a playback process in which, in a case where no playback list is designated, a playback list is obtained from the storage device in accordance with the use environment, and then audio content is played back in accordance with the playback list thus obtained.

The configuration allows the audio playback device to play back audio content in accordance with a use environment of the audio playback device.

In a third aspect of the present invention, an audio playback device may be configured to, in the second aspect, further include a motion sensor or a GPS receiver, the control device being configured to carry out: (i) an information acquiring process in which information about the use environment is obtained from (a) the motion sensor, (b) the GPS receiver, or (c) an application which is loaded from the storage device and is then executed; and (ii) a playback list selecting process in which the playback list is switched to another playback list in accordance with a change in use environment.

With the configuration, the audio playback device receives information about a use environment from (a) the motion sensor, (b) the GPS receiver, or (c) the application which is loaded from the storage device and is then executed, so as to play back audio content in accordance with a change in use environment.

An audio playback device in accordance with a fourth aspect of the present invention includes: a control device; a communication device; and a storage device configured to store therein a playback list, the control device being configured to carry out, via the communication device: (i) a determining process in which a state of a user, who operates the audio playback device, is determined; and (ii) a playback process in which, in a case where no playback list is designated, a playback list is obtained from the storage device in accordance with the state of the user, and then audio content is played back in accordance with the playback list thus obtained.

The configuration allows the audio playback device to play back audio content in accordance of a state of a user who operates the audio playback device.

In a fifth aspect of the present invention, an audio playback device may be configured to, in the fourth aspect, further include a human body sensor or a clock, the control device being configured to carry out: (i) an information acquiring process in which information about the state of the user is obtained from the human body sensor or the clock; and (ii) a playback list selecting process in which the playback list is switched to another playback list in accordance with a change in state of the user.

With the configuration, the audio playback device receives information about a user's state from the human body sensor or the clock, so as to play back audio content in accordance with a change in user's state.

In a sixth aspect of the present invention, an audio playback device may be configured such that, in the first aspect, the control device further carries out a storage process in which each playback position of a corresponding playback list is stored in the storage device.

The configuration makes it possible to uniform the frequency at which each audio content, in a playback list, is played back. In other words, each audio content, in a playback list, can be evenly played back.

A control device in accordance with a seventh aspect of the present invention is a control device for controlling an audio playback device, the control device being configured to carry out: (i) a determining process in which a type of an audio output device, which is connected to the audio playback device, is determined; and (ii) a playback process in which, in a case where no playback list is designated, a playback list is obtained in accordance with the type of the audio output device, and then audio content is played back in accordance with the playback list thus obtained.

The configuration realizes the control device, by which the audio playback device can play back audio content in accordance with a type of an audio output device connected thereto.

A control method in accordance with an eighth aspect of the present invention is a control method for controlling an audio playback device, the method including the steps of: (i) determining a type of an audio output device which is connected to the audio playback device; and (ii) obtaining, in a case where no playback list is designated, a playback list in accordance with the type of the audio output device, and then playing back audio content in accordance with the playback list thus obtained.

The configuration realizes the control method, by which the audio playback device can play back audio content in accordance with a type of an audio output device connected thereto.

The control device according to the foregoing embodiments of the present invention may be realized by a computer. In this case, the present invention encompasses: a program for the control device which program causes a computer to operate as the foregoing means (software elements) of the control device so that the control device can be realized by the computer; and a computer-readable storage medium storing the program therein.

[Additional Remarks]

The present invention is not limited to the foregoing embodiments, but can be altered by a skilled person in the art within the scope of the claims. The present invention also encompasses, in its technical scope, any embodiment derived by combining technical means disclosed in differing embodiments. Further, it is possible to form a new technical feature by combining the technical means disclosed in the respective embodiments.

### REFERENCE SIGNS LIST

1 Audio playback device

2 Speaker (audio output device)

3 Headphone (audio output device)

4 Car audio system (audio output device)

5 Audio playback system

11 Control section (control device)

12 Storage section (storage device)

13 Display section

14 Input section

15 Detection section

16 Communication section (communication device)

111 Audio output device determining section

112 Circumstance determining section

113 Audio playback section

114 Playback list creating section

115 Playback list selecting section

116 Playback list associating section

117 Communication device connecting section

118 Music decoding section

1. An audio playback device comprising:
a control device;
a communication device; and
a storage device configured to store therein a playback list,
said control device being configured to carry out, via the communication device:
(i) a determining process in which a type of an audio output device, which is connected to the audio playback device, is determined; and
(ii) a playback process in which, in a case where no playback list is designated, a playback list is obtained from the storage device in accordance with the type of the audio output device, and then audio content is played back in accordance with the playback list thus obtained.

2. An audio playback device comprising:
a control device;
a communication device; and
a storage device configured to store therein a playback list,
said control device being configured to carry out, via the communication device:
(i) a determining process in which a use environment of the audio playback device is determined; and
(ii) a playback process in which, in a case where no playback list is designated, a playback list is obtained from the storage device in accordance with the use environment, and then audio content is played back in accordance with the playback list thus obtained.

3. An audio playback device as set forth in claim 2, further comprising a motion sensor or a GPS receiver,
said control device being configured to carry out:
(i) an information acquiring process in which information about the use environment is obtained from (a) the motion sensor, (b) the GPS receiver, or (c) an application which is loaded from the storage device and is then executed; and
(ii) a playback list selecting process in which the playback list is switched to another playback list in accordance with a change in use environment.

4. An audio playback device comprising:
a control device;
a communication device; and
a storage device configured to store therein a playback list,
said control device being configured to carry out, via the communication device:
(i) a determining process in which a state of a user, who operates the audio playback device, is determined; and
(ii) a playback process in which, in a case where no playback list is designated, a playback list is obtained from the storage device, in accordance with the state of the user, and then audio content is played back in accordance with the playback list thus obtained.

5. An audio playback device as set forth in claim 4, further comprising a human body sensor or a clock,
said control device being configured to carry out:
(i) an information acquiring process in which information about the state of the user is obtained from the human body sensor or the clock; and
(ii) a playback list selecting process in which the playback list is switched to another playback list in accordance with a change in state of the user.

6. An audio playback device as set forth in claim 1, wherein said control device further carries out a storage process in which each playback position of a corresponding playback list is stored in the storage device.

7. A control device for controlling an audio playback device, said control device being configured to carry out:
(i) a determining process in which a type of an audio output device, which is connected to the audio playback device, is determined; and
(ii) a playback process in which, in a case where no playback list is designated, a playback list is obtained in accordance with the type of the audio output device, and then audio content is played back in accordance with the playback list thus obtained.

8. A control method for controlling an audio playback device, comprising the steps of:
(i) determining a type of an audio output device which is connected to the audio playback device; and
(ii) obtaining, in a case where no playback list is designated, a playback list in accordance with the type of the audio output device, and then playing back audio content in accordance with the playback list thus obtained.
